(19) United States
(12) Patent Application Publication
(10) Pub. No.: US 2024/0393253 A1
(43) Pub. Date: Nov. 28, 2024

(54) NANOPROBE FOR DIGITAL SURFACE ENHANCED RAMAN SCATTERING AND DIGITAL-BASED DIAGNOSTIC METHOD USING SAME

(71) Applicant: INDUSTRY-UNIVERSITY COOPERATION FOUNDATION HANYANG UNIVERSITY ERICA CAMPUS, Ansan-si (KR)

(72) Inventors: Jong-Ho KIM, Ansan-si (KR); Chanhee CHOI, Ansan-si (KR); In Jun HWANG, Ansan-si Gyeonggi-do (KR)

(21) Appl. No.: 18/796,988

(22) Filed: Aug. 7, 2024

Related U.S. Application Data
(63) Continuation of application No. PCT/KR2023/001792, filed on Feb. 8, 2023.

(30) Foreign Application Priority Data
Feb. 8, 2022 (KR) 10-2022-0016399
Jan. 25, 2023 (KR) 10-2023-0009238

(51) Int. Cl. G01N 21/65; B82Y 15/00; B82Y 30/00; G01N 21/552

(52) U.S. Cl. CPC G01N 21/658; B82Y 15/00; B82Y 30/00; G01N 21/554

(57) ABSTRACT

A surface-enhanced Raman scattering nanoprobe comprising: a nanoparticle; a Raman label bonded to a surface of the nanoparticle; and a first detection material bonded to the surface of the nanoparticle, wherein the first detection material can specifically bind to the target material to be detected, and a metal material generating a plasmonic effect is formed on a surface of the nanoparticle is provided.

### CROSS-REFERENCE TO RELATED APPLICATION

This application is a continuation of pending PCT International Application No. PCT/KR2023/001792, which was filed on Feb. 8, 2023, and which claims priority to Korean Patent Application No. 10-2022-0016399 which was filed in the Korean Intellectual Property Office on Feb. 8, 2022, and Korean Patent Application No. 10-2023-0009238 which was filed in the Korean Intellectual Property Office on Jan. 25, 2023. The disclosures of which are hereby incorporated by reference in their entireties.

### TECHNICAL FIELD

The present disclosure relates to a nanoprobe for digital surface enhanced Raman scattering and to a digital-based diagnostic method using same, and more particularly, to a nanoprobe for digital surface enhanced Raman scattering capable of accurately quantitatively detecting a trace of a biomarker by processing, in a digital manner, a SERS signal generated when a target biomarker is detected, and to a digital-based diagnostic method using same.

### BACKGROUND ART

A detection technology based on Surface-enhanced Raman scattering (hereinafter, SERS) has received much attention as a new disease diagnosis method that may replace the existing fluorescence/absorption detection method because sensitivity is very excellent and multi-detection is possible.

However, the SERS detection method has a limitation in that it is difficult to accurately quantitatively detect a low concentration of target biomarker due to spatial non-uniformity of signal intensity between hot spot of a SERS substrate or a SERS nanoprobe and temporal fluctuation of SERS signal intensity with time.

In particular, in order to accurately quantify and detect a very small amount of biomarkers in body fluids and to accurately diagnose diseases through this, it is essential to solve the fundamental limitations of such SERS detection technology, but a technology capable of effectively solving this problem has not yet been disclosed.

### DISCLOSURE

### Technical Problem

Accordingly, an object to be achieved by the present disclosure is to provide a probe that overcomes the limitations of SERS detection technology and a SERS-based diagnostic technology that utilizes the same.

### Technical Solution

In order to solve the above-described problems, the present disclosure provides a surface-enhanced Raman scattering nanoprobe which includes: a nanoparticle; a Raman label bonded to the surface of the nanoparticle; and a first detection material bonded to the surface of the nanoparticle and specifically bonded to a target material to be detected.

In an embodiment of the present disclosure, a metal material generating a plasmonic effect is formed on the surface of the nanoparticle, and the Raman label is formed in a gap between the metal materials.

In an exemplary embodiment of the present disclosure, the Raman label is simultaneously added in the metal material synthesis process to be formed on the surface of the nanoparticle.

The present disclosure provides a sandwich structure for digital surface-enhanced Raman scattering comprising: the above-described surface-enhanced Raman scattering nanoprobe; and magnetic beads to which a second detection material is bound, wherein the second detection material and the first detection material are simultaneously and complementarily bound with the target material.

In an embodiment of the present disclosure, the second detection quality specifically binds to the target material.

The present disclosure also provides a digital-based diagnostic method using the above-described digital surface-enhanced Raman scattering sandwich structure, the digital-based diagnostic method including: applying the above-described digital surface-enhanced Raman scattering sandwich structure to a plurality of wells; and detecting a surface-enhanced Raman signal (SERS) from the plurality of wells.

In an embodiment of the present disclosure, the digital-based diagnostic method detects a surface-enhanced Raman signal (SERS) from each of the plurality of wells, and detects the surface-enhanced Raman signal (SERS) by counting the number of cases where there is the digital surface-enhanced Raman scattering sandwich structure with respect to each of the plurality of wells as 1, and the number of cases where there is no digital surface-enhanced Raman scattering sandwich structure with respect to each of the plurality of wells as 0.

In an embodiment of the present disclosure, the counting to 1 counts to 1 when a signal having an intensity equal to or greater than a preset intensity compared to the noise signal is detected.

The present disclosure also provides a digital-based diagnostic method, further comprising calculating the concentration of the target substance by summing surface-enhanced Raman signals (SERS) from the plurality of wells.

### Advantageous Effects

According to the present disclosure, a digital SERS nanoprobe-based antigen assay capable of overcoming the limitations of the existing SERS detection method was developed, and a very small amount of biomarkers was accurately quantitatively detected (0 & 1 without and with targets) by digitally processing a SERS signal generated when detecting a target biomarker. Unlike the conventional detection method for detecting a biomarker by measuring the intensity of the entire SERS signal, the digital SERS nanoprobe antigen test method is not affected by a deviation in the intensity of the SERS signal depending on location and time, so that accurate quantitative detection of the biomarker is possible, and high-sensitivity detection of the biomarker can be implemented through single particle measurement.

### BRIEF DESCRIPTION OF DRAWINGS

FIG. 1 is a schematic diagram for explaining a method of manufacturing a digital SERS nanoprobe and a diagnostic method using the same according to an embodiment of the present disclosure.

FIG. 2A is a schematic diagram for synthesis of a digital SERS nanoprobe according to an embodiment of the present disclosure, and FIG. 2B is a TEM image of a SERS nanoprobe complex according to an embodiment of the present disclosure.

FIG. 3 is a plasmonic absorption spectrum of a digital SERS nanoprobe complex according to an embodiment of the present disclosure, and FIG. 4 shows different SERS signals for each type of detection material.

FIG. 5 is an optical image of an empty digital SERS measurement substrate (a) and a digital SERS measurement substrate with a SERS nanoprobe sandwich complex according to the present disclosure, and FIG. 6 is a SERS spectrum obtained from an empty well and a well with a SERS nanoprobe sandwich complex according to the present disclosure.

In FIG. 7, a is a microwell optical image of a digital SERS measurement substrate including a SERS nanoprobe sandwich according to an embodiment of the present disclosure, b is a diagram illustrating a case where results of 0 and 1 are obtained from a SERS spectrum obtained from a microwell with or without a SERS nanoprobe sandwich, and c is an optical image of a microwell digitized with SERS signal intensity obtained from each well.

FIG. 8 is a schematic diagram for digital measurement of an antigen biomarker using a digital SERS nanoprobe detection method in a microwell substrate.

FIG. 9 is a digitized SERS mapping image of microwells with or without a SERS nanoprobe sandwich complex for CA19-9 detection at concentrations from 0 to 250 U/mL (a if present, b if not).

FIG. 10 is a representative SERS spectrum obtained from microwells containing a SERS nanoprobe sandwich for CA19-9 detection.

FIG. 11 is a concentration dependent digital SERS signal as a function of CA19-9 concentration measured on a digital SERS measurement substrate.

### BEST MODE

Hereinafter, a preferred embodiment of the present disclosure will be described in detail with reference to the accompanying drawings.

Before describing the present disclosure in detail, the terms or words used in the present specification should not be interpreted as being unconditionally limited to typical or dictionary meanings, and the inventor of the present disclosure may appropriately define and use the concepts of various terms in order to describe his or her disclosure in the best way.

Furthermore, it should be noted that these terms or words should be interpreted as meanings and concepts consistent with the technical idea of the present disclosure.

That is, the terms used in the present specification are only used to describe the preferred embodiments of the present disclosure and are not intended to specifically limit the contents of the present disclosure.

It should be noted that these terms are defined in consideration of various possibilities of the present disclosure.

In addition, in the present specification, a singular expression may include a plural expression unless the context clearly indicates a different meaning.

In addition, it should be noted that even if it is similarly expressed in plural, it may include a singular meaning.

In the case of describing that a component “includes” another component throughout the specification, it may mean that any other component may be further included, rather than excluding any other component, unless otherwise described.

Furthermore, when a component is described as “present inside” or connected to and installed in another component, the component may be directly connected to or in contact with the other component.

To solve the above-described problems, the present disclosure provides a digital SERS nanoprobe-based antigen test method capable of overcoming the limitations of the existing SERS detection method.

The diagnostic method using a nanoprobe according to an embodiment of the present disclosure can accurately quantitatively detect a trace amount of biomarkers (0 & 1 without and with targets) by digitally processing the SERS signal generated when detecting a target biomarker. In addition, unlike the conventional detection method for detecting a biomarker by measuring the intensity of the entire SERS signal, the digital SERS nanoprobe antigen test method according to the present disclosure is not affected by a deviation of the intensity of the SERS signal depending on the position and time, so that accurate quantitative detection of the biomarker is possible, and high-sensitivity detection of the biomarker is possible through single particle measurement.

Describing the method according to an embodiment of the present disclosure in more detail, first, a biomarker is captured by using a magnetic particle to which a capture antibody (a second detection material) is fixed, and a SERS nanoprobe into which a detection antibody (a first detection material) is introduced is treated to make a SERS nanoprobe-magnetic particle sandwich complex.

Then, the SERS nanoprobe-magnetic particle sandwich solution is applied to a SERS measurement substrate composed of highly integrated well, and at this time, one SERS nanoprobe-magnetic particle sandwich complex is inserted into each well of the SERS measurement substrate, and then, the SERS signal is measured in each well.

In an embodiment of the present disclosure, even if a structure is present, a signal (e.g., 5 times or more) in which the intensity of the Raman signal is higher than noise by a predetermined level or more is counted as “1”, and when the Raman signal is not output or is less than a predetermined level, the intensity of the target biomarker is accurately quantitatively detected by counting as “0”. By using the “digital SERS nanoprobe antigen test method”, various diseases can be accurately and quickly diagnosed.

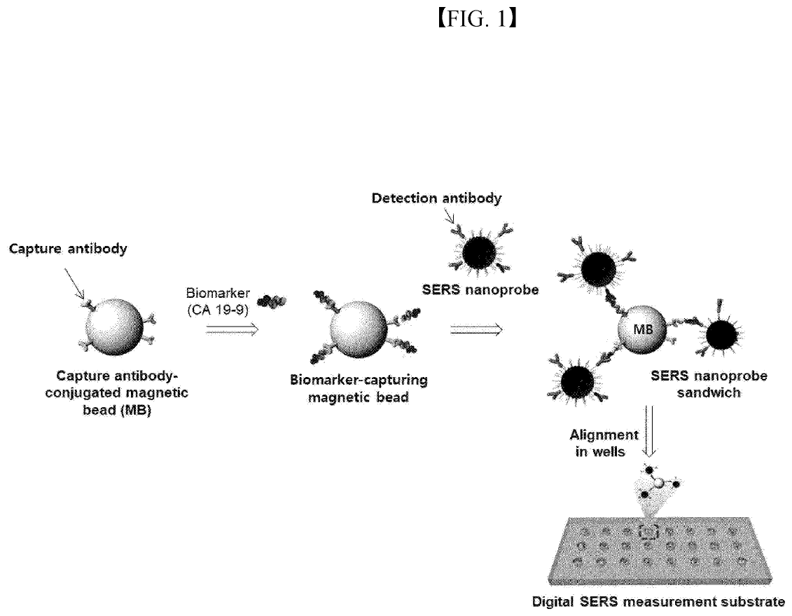

FIG. 1 is a schematic diagram for explaining a method of manufacturing a digital SERS nanoprobe and a diagnostic method using the same according to an embodiment of the present disclosure.

Referring to FIG. 1, the nanostructure according to an embodiment of the present disclosure is composed of nanoparticles for detecting magnetic beads-SERS, and the magnetic beads and the nanoparticles have a sandwich structure in which they are connected to an antigen, which is a biomarker, and an antibody complementarily bound thereto.

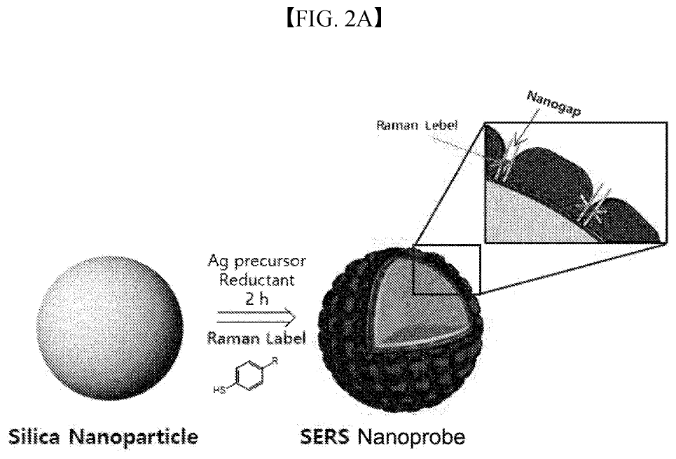

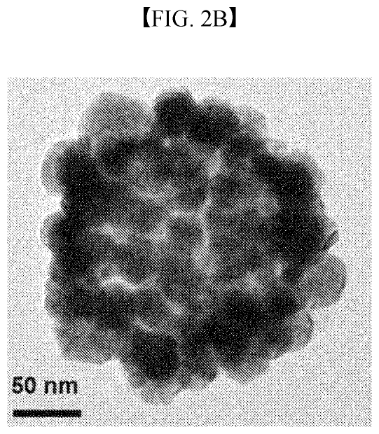

FIG. 2A is a schematic diagram for the synthesis of digital SERS nanoprobe particles according to an embodiment of the present disclosure, and FIG. 2B is a TEM image of a SERS nanoprobe complex according to an embodiment of the present disclosure.

Referring to FIGS. 2A and 2B, the nanoprobe according to an exemplary embodiment of the present disclosure has a structure in which a detection antibody is bound to the surface thereof based on silica nanoparticles, and a metal material generating a plasmonic effect and a Raman label are formed.

The SERS nanoprobe according to an embodiment of the present disclosure is prepared by adding a Raman label element during synthesis thereof based on silica. That is, Ag is reduced on the silica to form a gap between Ag materials, and at this time, the added Raman label is located between the gaps.

The SERS nanoprobe according to the present disclosure can be synthesized by using various Raman labels, having superior signal stability and structural stability after surface modification compared to the SERS nanoprobe of a conventional method for post-treating and synthesizing a Raman label.

Hereinafter, the present disclosure will be described in more detail with reference to Examples. However, the scope of the present disclosure is not limited by the following examples.

### Embodiment

SERS Nanoprobe-Based Immunoassay Production for Target Biomarker Detection

First, 8×106 25 μL per mL of capture antibody (CAb)-magnetic beads (MB) was dispersed in 425 μL of 1% BSA/PBS (0.1 m, pH 7.4) solution. 50 μL of the target biomarker, antigen, was added to the CAb-MB solution at a final concentration ranging from 0.01 to 10000 pg mL.

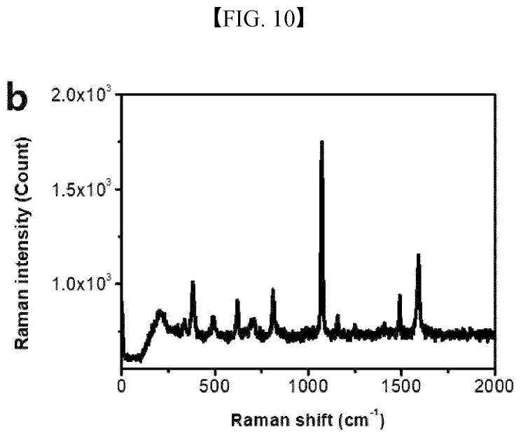

In one embodiment of the present disclosure, CA19-9, which is known as a biomarker of pancreatic cancer, was used as the antigen, and this can be confirmed in the x axis of FIG. 10 below.

Then, the resulting mixture was washed several times with incubation 1 m, pH 7.4 for 2 hours while gently shaking at room temperature.

Then, the antibody for detection (DAb) was incubated with bound SERS nanoparticles [4-FBT] or SERS nanoparticles [4-BBT] (25 μL, 0.2 mg mL-1) at room temperature for 2 hours (final solution volume=0.5 mL). Finally, the CAb-MB was washed several times with 0.1% PBS-T (0.1 m, pH 7.4) and PBS (0.1 m, pH 7.4) to remove unbound SERS nanoprobes, and then the entire solution of CAb-MB was dropped onto a microwell substrate to collect SERS signals from CAb-MB.

### Biomarker Detection Through Digital SERS Nanoprobe

10 μL of the SERS nanoprobe-based sandwich complex was dropped onto a microwell substrate for SERS signal measurement from SERS nanoprobes to detect target biomarkers. The microwell substrate was treated with a SERS nanoprobe sandwich composite to uniformly disperse the SERS nanoprobe-based sandwich composite in the microwell. SERS mapping was performed for each well in 5 μm steps in a 50 μm×50 μm area, the SERS signal was converted into “On(1)” and “Off(0)”, and the converted SERS signals were summed.

### Experimental Example

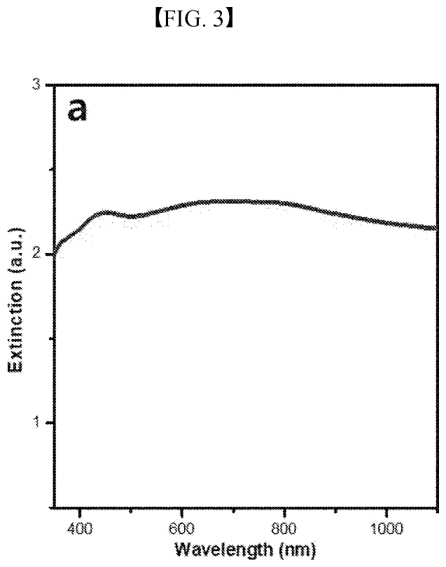

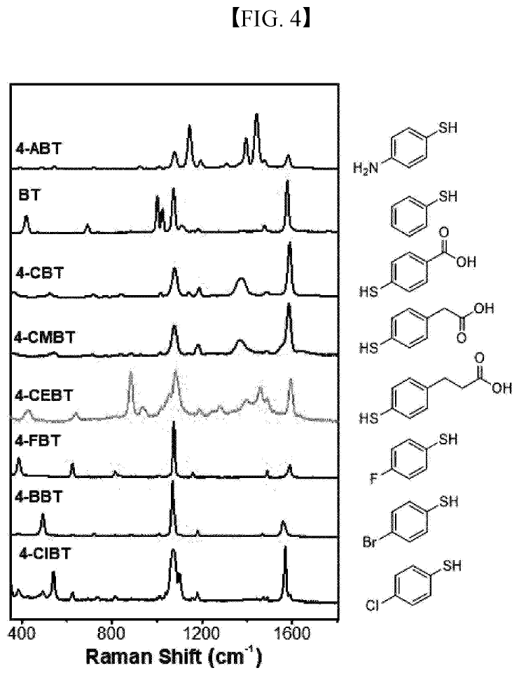

FIG. 3 is a plasmonic absorption spectrum of a digital SERS nanoprobe complex according to an embodiment of the present disclosure, and FIG. 4 shows SERS signals for each Raman label (compound of FIG. 4).

Referring to FIGS. 3 and 4, when the gap of the SERS nanoprobe according to the present disclosure is well formed, the absorbance near infrared increases (900 nm), and it can be seen that this is the same regardless of the Raman label used in the synthesis. In addition, the compound on the right side of FIG. 4 is a Raman label used in the synthesis, and the Raman spectrum on the left side is a SERS spectrum of the SERS nanoprobe synthesized using the corresponding Raman label.

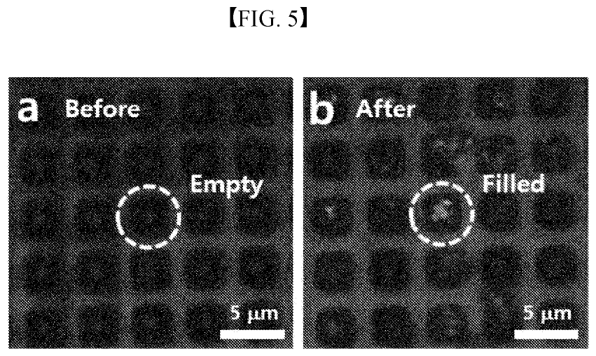

FIG. 5 is an optical image of an empty digital SERS measurement substrate (a) and a digital SERS measurement substrate with a SERS nanoprobe sandwich complex according to the present disclosure, and FIG. 6 is a SERS spectrum obtained from an empty well and a well with a SERS nanoprobe sandwich complex according to the present disclosure.

Referring to FIGS. 5 and 6, it can be seen that the presence or absence of the signal and the position thereof can be clearly confirmed in the well having the SERS nanoprobe sandwich complex according to the present disclosure.

FIG. 7 is a microwell optical image of a digital SERS measurement substrate containing a SERS nanoprobe sandwich according to an embodiment of the present disclosure, b) a diagram illustrating a case where results of 0 and 1 are obtained from a SERS spectrum obtained from microwells with or without a SERS nanoprobe sandwich, and c) an optical image of a microwell digitized with SERS signal intensity obtained from each well.

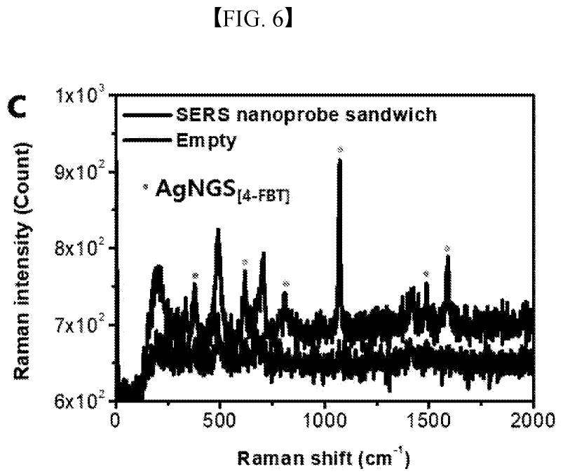

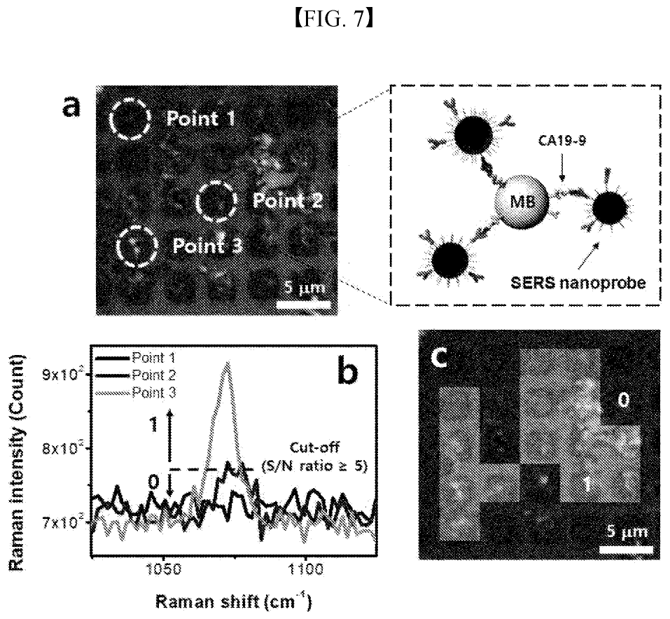

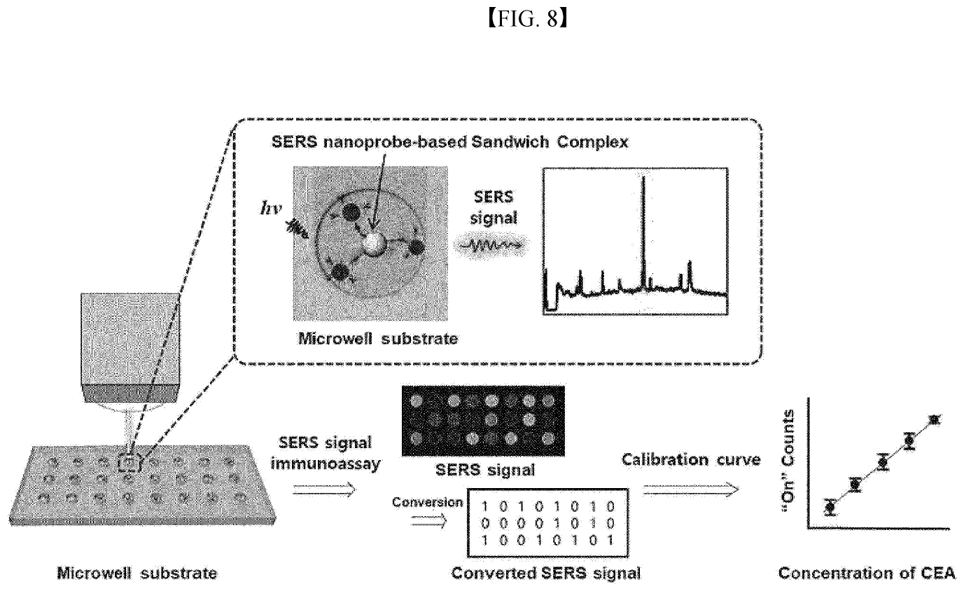

Referring to FIG. 7, it can be seen that 0 and 1 are distinguished from each other based on a cut-off criterion (signal/noise is 5 or more) in the signal detected in the well, and from this, a result counted as 0 and 1 as shown in FIG. 8 below may be obtained from the entire substrate.

FIG. 8 is a schematic diagram for digital measurement of an antigen biomarker using a digital SERS nanoprobe detection method in a microwell substrate.

Referring to FIG. 8, by using a digital method in which the presence or absence of a signal (1 when a signal is output, and 0 when a signal is not output) is distinguished, it is possible to detect a minute amount as well as the presence or absence of a target using the SERS technology.

That is, the present disclosure sums up the number of signals converted into “1”,which is a signal showing an intensity over a predetermined reference for noise, and a signal of “0”, which is not the same, thereby making it possible to measure the concentration according to the sum value as well as the presence or absence of a target in a digital method.

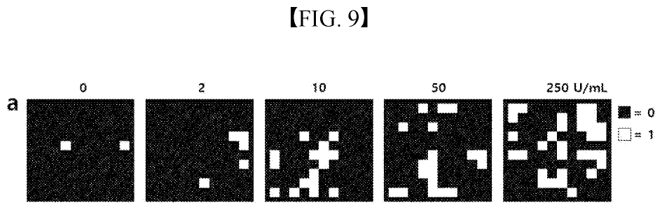

FIG. 9 is a digitized SERS mapping image of microwells with or without a SERS nanoprobe sandwich complex for CA19-9 detection at concentrations from 0 to 250 U/mL (a if present, b if not)

FIG. 10 is a representative SERS spectrum obtained from a microwell containing a SERS nanoprobe sandwich for CA19-9 detection.

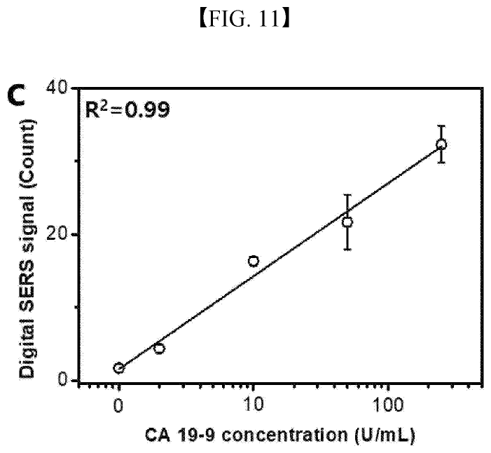

FIG. 11 is a concentration dependent digital SERS signal as a function of CA19-9 concentration measured on a digital SERS measurement substrate

FIG. 9 is an image obtained by converting the measured signal according to a predetermined criterion, and clearly shows a place where black is converted into “0” and white is converted into “1”, in which the SERS signal is measured through mapping after performing an assay according to the concentration of CA19-9.

FIG. 10 is an actual SERS spectrum of the place where the “1” signal appeared, and it can be confirmed from FIG. 9 that the signal of the SERS nanoprobe is well shown.

FIG. 11 is a graph illustrating a change in a signal according to a concentration of CA19-9 using an average and a standard deviation of signals by performing an experiment three times for each concentration range.

Referring to FIG. 11, it can be seen that the ratio increases linearly according to the concentration, and the correlation coefficient is 0.99, indicating that the linearity is also very high.

As described above, the present disclosure can accurately quantitatively detect an infinitesimal amount of biomarker (0 & 1 without and with targets) by digitally processing the SERS signal generated at the time of detecting the target biomarker (0 & 1 SERS), and unlike the existing detection method for detecting the biomarker by measuring the intensity of the entire SERS signal, the digital SERS nanoprobe antigen test method is not affected by the deviation of the intensity of the single particle signal depending on the location and time, so that accurate quantitative detection of the biomarker can be performed and high-sensitivity detection of the biomarker can be implemented through the measurement.

1. A surface-enhanced Raman scattering nanoprobe comprising:
a nanoparticle;
a Raman label bonded to a surface of the nanoparticle; and
a first detection material bonded to the surface of the nanoparticle, wherein the first detection material specifically binds to a target material to be detected, and a metal material generating a plasmonic effect is formed on the surface of the nanoparticle.

2. The surface-enhanced Raman scattering nanoprobe according to claim 1, wherein the Raman label is formed in a gap between metal materials.

3. The surface-enhanced Raman scattering nanoprobe according to claim 2, wherein the Raman label is simultaneously added in a synthesis process of the metal material to be formed on the surface of the nanoparticle.

4. A digital surface-enhanced Raman scattering sandwich structure including
the surface-enhanced Raman scattering nanoprobe according to claim 1 comprising
a magnetic bead to which a second detection material is bound, wherein the second detection material and the first detection material are complementarily bound with the target material at the same time.

5. A diagnostic method using the digital surface-enhanced Raman scattering sandwich structure according to claim 4 comprising
applying the digital surface-enhanced Raman scattering sandwich structure to a plurality of wells; and
detecting a surface enhanced Raman signal (SERS) from the plurality of wells.

6. The diagnostic method according to claim 5, wherein the diagnostic method detects the surface-enhanced Raman signal (SERS) from each of the plurality of wells.

7. The diagnostic method according to claim 6, wherein one (1) is counted when the digital surface enhanced Raman scattering sandwich structure exists for each of the plurality of wells, and zero (0) is counted when the digital surface enhanced Raman scattering sandwich structure does not exist for each of the plurality of wells and when a signal having a predetermined intensity or more compared to the noise signal is detected, one (1) is counted.

8. The diagnostic method according to claim 7, further comprising calculating concentration of the target material by summing surface-enhanced Raman signals (SERS) from the plurality of wells.
